(19) United States
(12) Patent Application Publication
(10) Pub. No.: US 2007/0153440 A1
(43) Pub. Date: Jul. 5, 2007

(54) Circuit for protecting motherboard

(75) Inventor: Chia-Wen Huang, Tu-Cheng (TW)

Correspondence Address: MORRIS MANNING MARTIN LLP, 3343 PEACHTREE ROAD, NE, 1600 ATLANTA FINANCIAL CENTER, ATLANTA, GA, 30326, US

(73) Assignee: HON HAI Precision Industry CO., LTD., Tu-Cheng City (TW)

(21) Appl. No.: 11/321,251

(22) Filed: Dec. 29, 2005

(51) Int. Cl. H02H 3/20

(52) U.S. Cl. 361/91.1

(57) ABSTRACT

A circuit for protecting a computer whose CPU power-on voltage on a motherboard is abnormal, includes a first transistor (Q1), a second transistor (Q2), and a third transistor (Q3). A base of the first transistor receives a signal to indicate the status of the CPU power-on voltage, and an emitter is connected to a ground. A base of the second transistor is connected to a collector of the first transistor, an emitter is connected to the ground, and a collector is connected to a control terminal (25) for creating a control signal. An emitter of the third transistor is connected to the collector of the first transistor, a base receives a first assistant signal, and a collector receives a second assistant signal. When the CPU power-on voltage is abnormal, the first transistor is switched off, and the second and third transistors is switched on to create the control signal for shutting off the computer.

### BACKGROUND

1. Technical Field

The present invention relates to a circuit, and more particularly to a circuit for protecting a motherboard from damage when the power supply connected to the CPU is unintentionally disconnected before a switching-on of the computer.

2. General Background

Recent technical innovations have created faster central processing units (CPUs) for speeding up the data processing rate of a computer. However, the faster CPUs need much greater power consumption. Conventional motherboards can not supply sufficient power to support these CPUs, so power supplies need to provide a special power cable for providing power to the CPU directly. At present, graphics card on motherboards also require this additional power directly provided by the power supply. In the future, more and more components on the motherboard will face the same problem, and they need to directly obtain power from the power supplies via special power cables.

As “Do It Yourself” becomes more and more popular, users often work with the motherboard themselves for removing or adding some components. As shown in FIG. 1, in this situation, the cables 13, 15 of the power supply 10 connected to the motherboard 20 sometimes need to be removed temporarily from the motherboard for easy reassembly. However, sometimes the user is apt to overlook some cables (such as cable 15 in FIG. 1), and forgets to put them back to the original connections. If the computer is powered on in this case, some components on the motherboard will not be able to run. Further, the motherboard and/or its components may be damaged due to this unintentional disconnection.

What is needed, therefore, is a circuit on a motherboard which can protect the motherboard and its components from damage in the above situation.

### SUMMARY

A circuit for protecting a computer whose CPU power-on voltage on a motherboard is abnormal, includes a first transistor, a second transistor, and a third transistor. A base of the first transistor receives a signal to indicate the status of the CPU power-on voltage which is received by a CPU receptacle in the motherboard, and an emitter is connected to a ground. A base of the second transistor is connected to a collector of the first transistor, an emitter is connected to the ground, and a collector is connected to a control terminal for creating a control signal. An emitter of the third transistor is connected to the collector of the first transistor, a base receives a first assistant signal, and a collector receives a second assistant signal. The first assistant signal and the second assistant signal are generated when the motherboard is powered on. When the motherboard is powered on, and the CPU power-on voltage is abnormal, the signal received by the CPU receptacle is in an activating status to switch off the first transistor, and the second and third transistors is switched on by the first and second assistant signal to create the control signal for shutting off the computer.

Other advantages and novel features will be drawn from the following detailed description of a preferred embodiment with attached drawings, in which:

### BRIEF DESCRIPTION OF THE DRAWINGS

FIG. 1 is a schematic view of a motherboard with a circuit for protecting the motherboard;

FIG. 2 is a schematic view of the circuit of FIG. 1 in accordance with a preferred embodiment of the present invention; and

FIG. 3 is a schematic view of a circuit for protecting a motherboard of FIG. 1 in accordance with another preferred embodiment of the present invention.

### DETAILED DESCRIPTION OF THE EMBODIMENTS

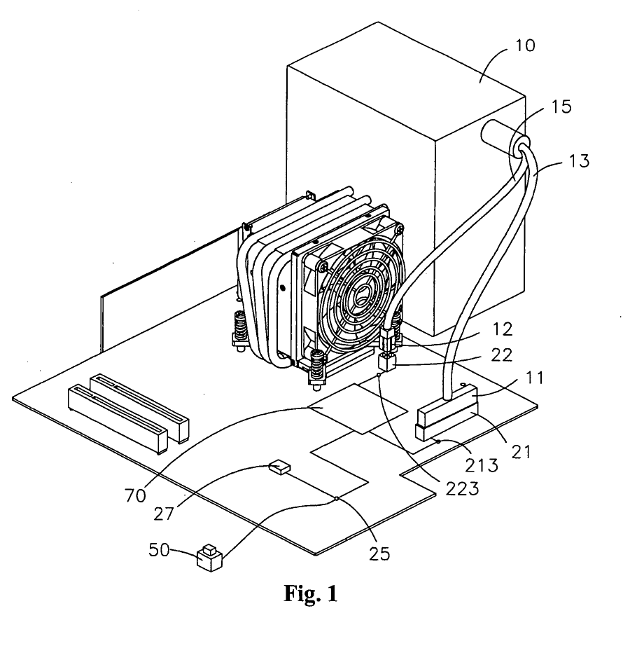

Referring to FIG. 1, a circuit 70 for protecting an electronic part like a motherboard 20 having electronic components thereon like a CPU in accordance with a preferred embodiment of the present invention is provided on the motherboard 20. The motherboard 20 includes a motherboard power receptacle 21 and a CPU power receptacle 22. A power supply 10 includes a first cable 13 with a motherboard power plug 11 corresponding to the motherboard power receptacle 21, and a second cable 15 with a CPU power plug 12 corresponding to the CPU power receptacle 22.

The motherboard power receptacle 21 includes a pin 213 used as a power signal source. When the power supply 10 is supplying correct power to the motherboard 20 and the CPU, the power supply will generates a signal PWROK to the motherboard via the pin 213 of the motherboard power receptacle 21 to indicate that the power supply is providing correct power to the motherboard and the CPU.

The CPU power receptacle 22 includes a pin 223 as another power signal source. When the CPU power-on voltage is normal, the pin 223 is enabled in high level. When the CPU power-on voltage is abnormal, the pin 223 is enabled in low level.

The motherboard 20 also includes a control terminal 25 that is connected with a power button 50. The control terminal 25 is used to power on or shut off the computer based on user signals from the power button 50. The control terminal 25 is high level in normal condition. When the power button 50 is pressed, a undershoot will be created on the control terminal 25 to be provided to a super I/O chip 27 to control powering on or shutting off of the computer.

As shown in FIG. 1, the motherboard power plug 11 is inserted in the motherboard power receptacle 21 for providing power to the motherboard 20, but the CPU power plug 12 is not inserted in the CPU power receptacle 22. The circuit 70 is applying to protect the motherboard 10 from damage in above situation.

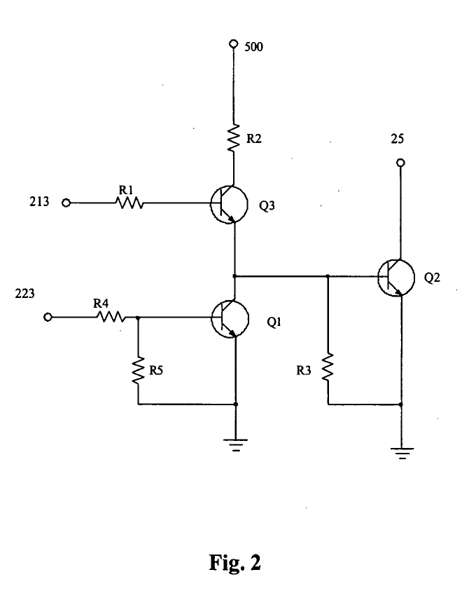

Referring to FIG. 2, the circuit 70 includes a first transistor Q1, a second transistor Q2, and the third transistor Q3. A base of the first transistor Q1 is coupled to a pin 223 of the CPU power receptacle 22 via a fourth resistor R4. An emitter of the first transistor Q1 is connected to ground. A collector of the first transistor Q1 is coupled to a base of the second transistor Q2. A fifth resistor R5 is coupled between the base and the emitter of the first transistor Q1 serving as a voltage grading resistor.

An emitter of the second transistor Q2 is connected to ground. A collector of the second transistor Q2 is coupled to the control terminal 25. A resistor R3 is coupled between the base and the emitter of the second transistor Q2 serving as a voltage grading resistor.

An emitter of the third transistor Q3 is coupled to the collector of the first transistor Q1 and the base of the second transistor Q2. A base of the third transistor Q3 is coupled to the pin 213 via a first resistor R1. A collector of the third transistor Q3 is coupled to a terminal 500 via a second resistor R2. A high level signal is created on the terminal 500 when the computer is powered on.

When the power button 50 of the computer is pressed, a undershoot is created on the control terminal 25 to power on the computer. The high level signal PWROK is created on the pin 213.

Then, if the CPU power-on voltage is abnormal, the following occurs. The pin 223 is enabled in low level, the first transistor Q1 is switched off, the pin 213 is high level, and the third transistor Q3 is switched on. The high level signal on the terminal 500 is transferred to the emitter of the third transistor Q3 from the collector of the third transistor Q3. The base of the transistor Q2 is enabled in high level, the second transistor Q2 is switched on, and the collector of the second transistor Q2 and the control terminal 25 connect to ground to create a undershoot on the control terminal 25. Then the computer is shut off to protect the motherboard 20 and its components.

If the CPU power-on voltage is normal, the following occurs. The pin 223 is enabled in high level, the first transistor Q1 is switched on, and the collector of the first transistor Q1 connects to ground. The base of the second transistor Q2 also connects to ground. The second transistor Q2 is switched off. The control terminal 25 is not connected to ground, and the computer keeps running.

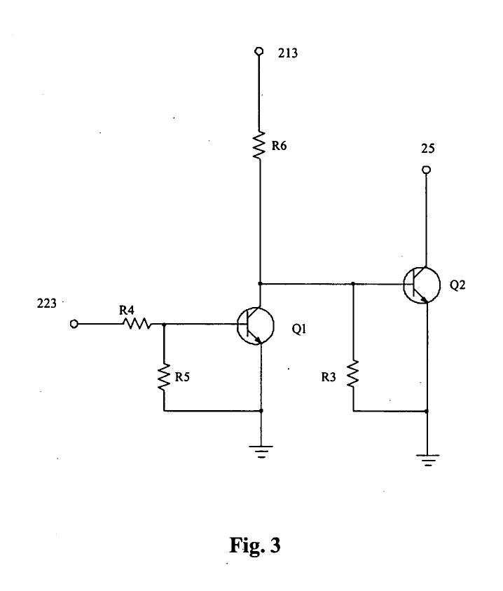

Referring to FIG. 3, another circuit for protecting the motherboard 20 is shown. The circuit of FIG. 3 is similar to the circuit of the FIG. 2, but the third transistor Q3 is omitted. The pin 213 connects to the collector of the first transistor Q1 and the base of the second transistor Q2 via a sixth resistor R6. When the power button 50 of the computer is pressed, a undershoot is created on the control terminal 25 to power on the computer. The high level signal PWROK is created on the pin 213.

If the CPU power-on voltage signal 100 is abnormal, the following occurs. The pin 223 is enabled in low level, the first transistor Q1 is switched off, the high level signal on the pin 213 is transferred to the base of the second transistor Q2, the second transistor Q2 is switched on, and the collector of the second transistor Q2 and the control terminal 25 connect to ground to create a undershoot on the control terminal 25. Then computer is shut off to protect the motherboard 20 and its components.

If the CPU power-on voltage signal 100 is normal, the following occurs. The pin 223 is enabled in high level, the first transistor Q1 is switched on, and the collector of the first transistor Q1 connects to ground. The base of the second transistor Q2 also connects to ground. The second transistor Q2 is switched off. The control terminal 25 is not connected to ground, and the computer keeps running.

It is to be understood, however, that even though numerous characteristics and advantages have been set forth in the foregoing description of preferred embodiments, together with details of the structures and functions of the preferred embodiments, the disclosure is illustrative only, and changes may be made in detail, especially in matters of shape, size, and arrangement of parts within principles of the invention to the full extent indicated by the broad meaning of the terms in which the appended claims are expressed.

What is claimed is:

1. A circuit for protecting a computer whose CPU power-on voltage on a motherboard is abnormal, comprising:
a first transistor comprising a base for receiving a signal to indicate the status of the CPU power-on voltage which is received by a CPU receptacle in the motherboard, and an emitter connected to a ground;
a second transistor comprising a base connected to a collector of the first transistor, an emitter connected to the ground, and a collector connected to a control terminal for creating a control signal; and
a third transistor comprising an emitter connected to the collector of the first transistor, a base for receiving a first assistant signal, and a collector for receiving a second assistant signal, the first assistant signal and the second assistant signal being generated when the motherboard is powered on;
wherein when the motherboard is powered on, and the CPU power-on voltage is abnormal, the signal received by the CPU receptacle is in an activating status to switch off the first transistor, and the second and third transistors switched on by the first and second assistant signal to create the control signal for shutting off the computer.

2. The circuit as described in claim 1, wherein the control signal is a undershoot signal that causes the computer powered on or shut off.

3. The circuit as described in claim 1, wherein the first signal is generated when the power supply supplies correct power to the motherboard and the CPU.

4. The circuit as described in claim 1, wherein the first and second assistant signals are high level signals.

5. The circuit as described in claim 1, wherein a resistor is coupled between the base and the emitter of the first transistor serving as a voltage grading resistor, and another resistor is coupled between the base and the emitter of the second transistor serving as a voltage grading resistor.

6. The circuit as described in claim 1, wherein a resistor is coupled to the base of the third transistor, and a resistor is coupled to the collector of the third transistor.

7. A circuit for protecting a computer whose CPU power-on voltage on a motherboard is abnormal, comprising:
a first transistor comprising a base for receiving a signal to indicate the status of the CPU power-on voltage which is received by a CPU receptacle in the motherboard, a collector connected to an assistant signal which is generated when a power supply supplies correct power to the motherboard and the CPU, and an emitter connected to a ground;
a second transistor comprising a base connected to the collector of the first transistor, an emitter connected to the ground, and a collector connected to a control terminal for creating a control signal; and
wherein when the motherboard is powered on, and the CPU is abnormal, the voltage signal provided by the CPU receptacle is in an activating status to switch off the first transistor, and the second transistor switched on by the first and second assistant signal to create the control signal for shutting off the computer.

8. The circuit as described in claim 7, the control signal is a undershoot signal that causes the computer powered on or shut off.

9. The circuit as described in claim 7, wherein the assistant signal is high level signals.

10. The circuit as described in claim 9, wherein a resistor is coupled between the base and the emitter of the first transistor serving as a voltage grading resistor, and another resistor is coupled between the base and the emitter of the second transistor serving as a voltage grading resistor.

11. The circuit as described in claim 9, wherein a resistor is coupled to the collector of the third transistor.

12. A circuit assembly for controllably powering an electronic part, comprising:
a power control terminal capable of accepting user signals and providing control signals to power an electronic part;
a first power signal source capable of providing first power signals to indicate a powering status of an electronic component of said electronic part;
a second power signal source capable of providing second power signals to indicate a powering status of said electronic part to be powered;
a first switch electrically connectable between said first power signal source and said second power signal source so as to selectively output said first power signals of said first power signal source based on said second power signals accepted by said first switch; and
a second switch electrically connectable between said first switch and said power control terminal so as to selectively enable and disable said control signals of said power control terminal based on output of said first switch.

13. The circuit assembly as described in claim 12, wherein said first and second switches are transistors.
